(19) United States
(12) Patent Application Publication
(10) Pub. No.: US 2015/0006532 A1
(43) Pub. Date: Jan. 1, 2015

(54) STABLE PAIR-WISE E-VALUE

(71) Applicant: DOW AGROSCIENCES LLC, Indianapolis, IN (US)

(72) Inventors: Rod A. Herman, New Ross, IN (US); Ping Song, Carmel, IN (US)

(21) Appl. No.: 14/372,930

(22) PCT Filed: Jan. 17, 2013
(86) PCT No.: PCT/US2013/021856

§ 371 Date: Jul. 17, 2014

Related U.S. Application Data
(60) Provisional application No. 61/587,793, filed on Jan. 18, 2012.

(51) Int. Cl. G06F 17/30; G06F 19/28

(52) U.S. Cl. CPC G06F 17/30598; G06F 17/30548; G06F 19/28
USPC 707/737

(57) ABSTRACT

This invention is related to systems and methods for obtaining a bioinformatic pair-wise E-value that is stable and not dependent on the size of a protein or nucleic acid sequence database. Exemplary embodiments are provided for defining at least one database for each protein contained in a multi-protein database and generating E-values between a query protein and each protein in each single-protein database provides a stable pair-wise E-value for each query-to-database protein comparison.

### CROSS-REFERENCE TO RELATED APPLICATIONS

This Application claims the benefit of U.S. Provisional Application 61/587,793 filed on Jan. 18, 2012, which is expressly incorporated by reference herein.

### FIELD OF THE INVENTION

This invention is generally related to the field of bioinformatics, and more specifically the field of allergen discovery and sequence alignment.

### BACKGROUND OF THE INVENTION

In bioinformatic investigations, E-values have been used as a statistical measure to evaluate the relatedness of proteins based on their amino-acid sequence identity and similarity. In general, the lower the E-value, the more likely that two proteins are evolutionarily related and share similar structure and function. The statistical nature of E-value calculation takes into consideration the number and/or length of the proteins in the database that is being queried to assess the probability that amino-acid alignments are random or have evolutionary or biological significance.

In a regulatory context, bioinformatic investigations have been used to evaluate if transgenic proteins share biologically meaningful relatedness to known toxin and allergens. Current guidance for allergen searches is primarily based on amino-acid identity over specific contiguous stretches within a protein (e.g., an exact match of eight contiguous amino acids or >35% identity over an 80 amino-acid stretch). When bioinformatic investigations show a likelihood that a transgenic protein might be a cross-reactive allergen or toxin, governmental regulatory authorities typically require biological testing to ensure the transgenic protein is safe for human and/or animal use. However, the biological testings are often expensive and time-consuming Thus, false-positives from bioinformatic investigations can significant delay or prevent (in an economical way) useful products of transgenic proteins from reaching the market.

More recently, it has been suggested that E-values be used as a criterion/threshold to reduce false-positive rates by selecting only biologically meaningful homologies for further bioinformatic evaluation. However, because E-value depends on the size of database used, the calculated E-value for a given comparison between a specific query protein and a specific database protein will change over time as additional protein sequences are added to a database. This “evolving” or unstable E-value creates a challenging issue for deciding an E-value threshold for regulatory or scientific purposes. Thus, there remains a need for methodology which can use the threshold E-value independent of the size of database efficiently and accurately.

### SUMMARY OF THE INVENTION

This invention is related to systems and methods for obtaining a bioinformatic pair-wise E-value that is stable and not dependent on the size of a protein sequence database. Exemplary embodiments are provided for defining at least one database for each protein contained in a multi-protein database and generating E-values between a query protein and each protein in each single-protein database thus providing a stable pair-wise E-value for each query-to-database protein comparison.

In one aspect, provided is a computerized system for stable pair-wise E-value generation and/or allergen classification for a query sequence. The system comprises:
(a) an input device and an output device/interface;
(b) an analysis system interface coupled to memory of a computer;
(c) an operating system comprising at least one database;
(d) a stable pair-wise E-value module; and
(e) a classification module.

In one embodiment, the input device is selected from the group consisting of any amino acid sequence, automated sequencer, sequencing data input device, and sequencing data storage device. In another embodiment, the output interface comprises a list of potential allergen hits. In another embodiment, the at least one database comprises a consensus allergen database. In a further or alternative embodiment, the at least one database comprises a database derived from the National Center for Biotechnology Information (NCBI).

In one embodiment, the stable pair-wise E-value module generates one stable pair-wise E-value for the query sequence against each sequence in the database used. In another embodiment, the classification module classifies the query sequences based on a pre-determined E-value. In another embodiment, the classification module classifies sequences in the database used based on a pre-determined E-value. In one embodiment, the pre-determined E-value is equal or less than 0.1. In another embodiment, the pre-determined E-value is from 0.1 to 1×10⁻¹⁰. In one embodiment, the stable pair-wise E-value is independent of the size of database used. In another embodiment, the stable pair-wise E-value against the query sequence of a particular sequence is independent of the database used.

In another aspect, provided is a method for use in a computerized system for stable pair-wise E-value generation and/or allergen classification for a query sequence. The method comprises:
(a) generating a stable pair-wise E-value for the query sequence against each sequence in a first database using a stable pair-wise E-value module; and
(b) classifying the sequences in the database based on a pre-determined E-value using a classification module.

In another aspect, provided is a method for use in a computerized system for stable pair-wise E-value generation and/or allergen classification for query sequences. The method comprises:
(a) generating stable pair-wise E-values for the query sequences against each sequence in a first database using a stable pair-wise E-value module; and
(b) classifying the query sequences based on a pre-determined E-value using a classification module.

In another aspect, provided is a method for use in a computerized system for stable pair-wise E-value generation and/or allergen classification for a query sequence. The method comprises:
(a) generating a stable pair-wise E-value for the query sequence against each sequence in a first database using a stable pair-wise E-value module; and
(b) classifying the query sequence based on a pre-determined E-value using a classification module.

In one embodiment, the method further comprises outputting a list of potential allergen hits to a user. In a further or alternative embodiment, the list of potential allergen hits comprises sequence alignments with the query sequence. In a further or alternative embodiment, the list of potential allergen hits comprises sequence alignments between the query sequence and each of the known allergens in the database. In a further or alternative embodiment, the sequence alignments are performed using a FASTA search tool or Basic Local Alignment Search Tool (BLAST).

In another embodiment, the method further comprises repeating steps (a) and (b) with a second database. In a further or alternative embodiment, the first or second database is derived from the National Center for Biotechnology Information (NCBI). In another embodiment, the first database comprises a consensus allergen database. In another embodiment, the method further comprises repeating steps (a) and (b) with a different query sequence. In another embodiment, the computerized system comprises a system described herein.

In one embodiment, the pre-determined E-value is equal or less than 0.1. In another embodiment, the pre-determined E-value is from 0.1 to 1×10⁻¹⁰. In another embodiment, the pair-wise E-value is independent of the size of database. In another embodiment, the pair-wise E-value against the query sequence of a particular sequence is independent of the database.

In one embodiment, the query sequence is a protein sequence. In another embodiment, the query sequence is a nucleic acid sequence. In a further embodiment, the nucleic acid sequence is a DNA or RNA sequence. In another embodiment, the query sequence is a sequence from a transgenic event or transgenic plant. In a further or alternative embodiment, the transgenic event or transgenic plant is selected from transgenic corn, canola, soybean, sunflower, cotton, wheat, or rice.

### BRIEF DESCRIPTION OF THE DRAWINGS

FIG. 1 shows an exemplary embodiment of the systems and methods provided herein. The sequence of a query protein is input into a stable pair-wise E-value module for generating a pair-wise E-value with each sequence in a selected allergen database. All the stable pair-wise E-values (against each sequence in the selected allergen database) are then input into a classification module for determining allergen potential of the query protein.

FIG. 2 shows an exemplary protein sequence used in examples herein (SEQ ID NO: 1). This sequence comprises 30 amino acids from a major allergen I plus 30 amino acids of Cry1F.

FIG. 3 shows an exemplary E-value from the search against GenBank non-redundant protein sequences. The database size is shown as 14,481,394 sequences. The E-value is shown as 7.3×10⁻⁹ to major allergen I polypeptide chain 1.

FIG. 4 shows an exemplary E-value from the search against the consensus allergen database V11. The database size is shown as 1,489 sequences. The E-value is shown as 8×10^{—15} to major allergen I polypeptide. This E-value is much smaller as compared to FIG. 3 because of the smaller database.

FIG. 5 shows an exemplary E-value from the search against the consensus allergen database V10. The database size is shown as 1,471 sequences. The E-value is shown as 7.8×10⁻¹⁵ to major allergen I polypeptide. This E-value is also much smaller as compared to FIG. 3 because of the smaller database.

FIG. 6 shows an exemplary E-value from the search against the consensus allergen database V11 (truncated). The database size is shown as 1,469 sequences. The E-value is shown as 1.3×10⁻¹⁵ to major allergen I polypeptide. This E-value is also much smaller as compared to FIG. 3 because of the smaller database.

FIG. 7 shows an extreme E-value from a database with only one sequence—the major allergen I polypeptide. The E-value is shown as 6.3×10⁻¹⁹ to major allergen I polypeptide. This E-value is much smaller as compared to FIGS. 3-6 because of the database is extremely small with only one sequence.

FIG. 8 shows a summary of E-values calculated from different databases according to FIGS. 3-7.

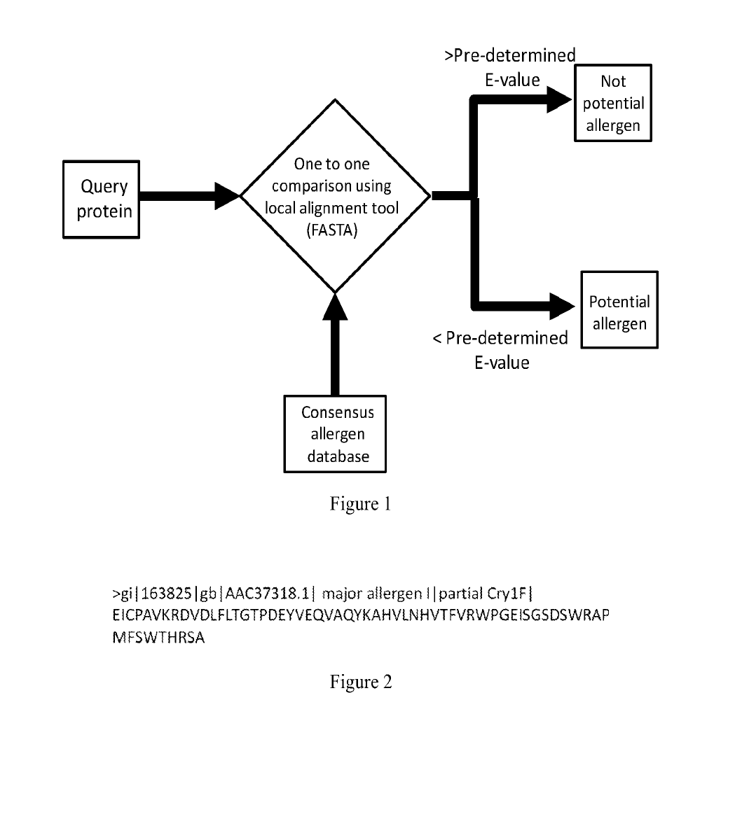

### DETAILED DESCRIPTION OF THE INVENTION

Systems and methods for generating a stable pair-wise E-value are provided. In some embodiments, the generated stable pair-wise E-value does not depend on the size of a database (number of sequence always equals to one). Specifically, defining at least one database for each protein contained in a multi-protein database and generating E-values between a query protein and each protein in each single-protein database provides a stable pair-wise E-value for each query-to-database protein comparison. This stability in E-value values allows a threshold value to be determined and/or assigned within a regulatory context (and also within a scientific context) against which specific pair-wise protein comparisons can be made.

The Food and Agriculture Organization of the United Nations (FAO) and World Health Organization (WHO) establish criteria for allergen screening of transgenic protein based on IgE cross-reactivity prediction using (1) an identity of at least six contiguous amino acids; or (2) a “sliding window” of 80 amino acids for an identity greater than 35%. However, the criteria established by FAO/WHO can generate too many false positive. See e.g., Cressman and Ladics (2009) “Further evaluation of the utility of ‘Sliding Window’ FASTA in predicting cross-reactivity with allergenic proteins.” Regul. Toxicol. Pharmacol. 54:S20-S25, the content of which is incorporated by reference in its entirety.

Alternatively, a motif-based allergenicity prediction system has been proposed to mitigate the false positive issue for allergen prediction, based on the assertion that most allergens can be matched by only 52 allergen motifs. See Stadler and Stadler (2003) FASEB 17: 1141-43, the content of which is incorporated by reference in its entirety.

Previously, E-value has been suggested to be considered as criteria for allergen prediction. See e.g., Ladics et al. (2007) “Comparison of conventional FASTA identity searches with the 80 amino acid sliding window FASTA search for the elucidation of potential identities to known allergens.” Molecular Nutrition & Food Research 51: 985-998, the content of which is incorporated by reference in its entirety. However, one challenging issue of the E-value is that the same pair-wise comparison would differ over time as a database changes in size.

As used herein, the phrase “amino acid” refers to a molecule having the structure wherein a central carbon atom (the alpha (α)-carbon atom, or “Cα”) is linked to a hydrogen atom, a carboxylic acid group (the carbon atom of which is referred to herein as a “carboxyl carbon atom”), an amino group (the nitrogen atom of which is referred to herein as an “amino nitrogen atom”), and a side chain group, R. When incorporated into a peptide, polypeptide, or protein, an amino acid loses one or more atoms of its amino and carboxylic groups in the dehydration reaction that links one amino acid to another. As a result, when incorporated into a protein, an amino acid is referred to as an “amino acid residue.” In the case of naturally occurring proteins, an amino acid residue's R group differentiates the 20 amino acids from which proteins are typically synthesized.

As used herein, the phrase “protein” refers to any polymer of two or more individual amino acids (whether or not naturally occurring) linked via a peptide bond, and occurs when the carboxyl carbon atom of the carboxylic acid group bonded to the α-carbon of one amino acid (or amino acid residue) becomes covalently bound to the amino nitrogen atom of amino group bonded to the α-carbon of an adjacent amino acid. These peptide bond linkages, and the atoms comprising them (i.e., α-carbon atoms, carboxyl carbon atoms (and their substituent oxygen atoms), and amino nitrogen atoms (and their substituent hydrogen atoms)) form the “polypeptide backbone” of the protein. The polypeptide backbone shall be understood to refer the amino nitrogen atoms, α-carbon atoms, and carboxyl carbon atoms of the protein.

Further, the phrase “protein” is understood to include the phrases “polypeptide” and “peptide” (which, at times, may be used interchangeably herein). Molecules comprising multiple polypeptide subunits (e.g., DNA polymerase IE, RNA polymerase II) or other components (for example, an RNA molecule, as occurs in telomerase) are included within the meaning of “protein” as used herein. Fragments of proteins and polypeptides are also within the scope of the invention and may be referred to herein as “proteins.” A protein “domain” refers to mean a portion of a larger protein which, in isolation, assumes a three dimensional conformation corresponding to the conformation the domain assumes when it exists in the larger protein.

As used herein, the phrase “computer useable medium” refers to media including removable storage devices and signals. “Computer useable medium” also refers to software or program instructions to a computer system. Computer programs (also called computer control logic) are stored in a main memory and/or on a secondary memory and can also be received and transmitted via a communications interface. Such computer programs, when executed, enable the computer system to perform the features of the present invention as discussed herein.

A used herein, the phrase “identity” refers to the number of sequence positions which are identical in an alignment. In most cases, it is indicated as a percentage of the alignment length.

TABLE 1
List of conservative substitutions for amino acid residues

| Group | Amino Acids |
|---|---|
| Small side chain | Alanine (Ala or A); Glycine (Gly or G); |
| | and Serine (Ser or S) |
| Positive charged | Arginine (Arg or R); Lysine (Lys or L); |
| | and Histidine (His or H) |
| Negative charged | Aspartic acid (Asp or D) and Glutamic acid |
| | (Glu or E) |
| Amine group | Asparagine (Asn or N) and Glutamine (Glu or Q) |
| Polar group | Cysteine (Cys or C); Serine (Ser or S); and |
| | Threonine (Thr or T) |
| Sulfhydryl group | Cysteine (Cys or C) and Methionine (Met or M) |
| Large hydrophobic | Valine (Val or V) Leucine (Leu or L); Isoleucine |
| group | (Ile or I); and Methionine (Met or M) |
| Aromatic group | Tyrosine (Tyr or Y); Tryptophan (Trp or W); |
| | Phenylalnine (Phe or F); Histidine (His or H) |

As used herein, the phrase “similarity” refers to the number of sequence positions which are similar (for example, conservative substitutions) in an alignment. In comparison with the corresponding regions of the naturally occurring polypeptides, the polypeptides according to the invention can have deletions or amino acid substitutions as long as they still exert at least one biological activity of the complete polypeptides. Conservative substitutions encompass variations of amino acids, where one amino acid being replaced by another amino acid from among the following groups: small side chain, positive charged, negative charged, amine group, polar group, sulfhydryl group, large hydrophobic group, and aromatic group shown in Table 1.

As used herein, the phrase “homology” refers to evolutionary relationship. Two homologous proteins have developed from a joint precursor sequence. Homology does not necessarily imply identity or similarity, apart from the fact that homologous sequences are usually more similar (or have more identical positions in an alignment) than non-homologous sequences.

As used herein, the phrase “orthologues” or “orthologous” refers to a functional counterpart, for example a protein in another organism, both having developed from a shared precursor. Typically, orthologues retain a shared function. In contrast, “paralogues” are genes or proteins resulting therefrom which have originated by duplication within a genome and which have assumed different functions during evolution which may still have similarity with each other.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale.

In the field of bioinformatics, FASTA format was introduced by Bill Pearson and David Lipman in 1988 for representing either nucleotide or amino acid sequences (see Pearson and Lipman, “Improved tolls for biological sequence comparison” (1988) Proc. Natl. Acad. Sci. USA 85:2444-2448), the content of which is incorporated by reference in its entirety. Basically, a sequence in FASTA format is a text-based format beginning with a single-line description containing a greater-than symbol (>) in first column, followed by lines of sequence data.

Commonly used alignment tools for both nucleic acid and amino acid sequences include Basic Local Alignment Search Tool (BLAST) and FASTA. See Altschul et al. (1990) J. Mol. Biol. 215: 403-410, and Pearson W R and Lipman D J (1988) Proc Natl Acad Sci USA 85(8): 2444-8, the contents of which are herein incorporated by reference in their entireties.

The amino acid similarity between two proteins is often investigated using automated bioinformatic alignment tools. The likelihood that a resulting alignment is meaningful is often evaluated using statistical tools and represented by an expect value (E-value). Previously, E-values are dependent on the query length and the database size. E-values have been suggested as an alternative to required amino-acid identity searches as a more informative tool, but have been criticized because E-values change as the database size changes.

Current E-values between two specific protein sequences (one query and one database protein) will change as the database size changes even though the relationship between the two proteins does not change. This creates a situation where a threshold value for similarity might be reached in one query but not exceeded in a later query when the database has additional entries. This is especially unacceptable to regulatory authorities that must maintain clear regulatory oversight for transgenic crops. Stable pair-wise E-values, as described here, should allow stable pair-wise thresholds to be generated.

The systems and methods described herein provide a means to generate stable pair-wise E-values that will not change as the database size increases (or decreases). Accordingly to the system and methods provided, each query protein is compared with each protein in the databases and E-values can be determined for each pair (query and database protein) in isolation from other proteins in the database. Thus, the E-values determined according to the systems and methods provided do not change as the multi-protein database size changes.

In some embodiments, the systems and methods disclosed herein can be applicable to both nucleic acid (for example, DNA or RNA sequences) and amino acid sequences. The protein-encoding genes, and/or the polypeptides encoded by them, of the databases can be compared with each other in a pair-wise comparison (for example, each DNA with each DNA; each polypeptide with each polypeptide) in order to find homologous similarities. In some embodiments, the Smith-Waterman algorithm can be used for the pair-wise comparison.

To assess whether a given alignment constitutes evidence for homology, an alignment can be evaluated from chance alone. A local alignment without gaps consists simply of a pair of equal length segments, one from each of the two sequences being compared. A modification of the Smith-Waterman or Sellers algorithms can find all segment pairs whose “scores” cannot be improved by extension or trimming. These are called high-scoring segment pairs (HSPs). To analyze how high a score is likely to arise by chance, a model of random sequences is needed. The measure for the similarity which is obtained is therefore an E-value (expect-value). The E-value indicates the probability of which the existing agreement between two proteins or else genes or nucleic acids is due to pure random chance. In general, the smaller the E-value, the more significant a hit in the search. In the case of two identical sequences, the E-value thus progresses towards zero. In the case of two entirely unrelated sequences, the E-value converges to values greater than one.

In one embodiment, a profile is generated as reported by Gribskov et al. (1987) Proc. Natl. Acad. Sci. USA 84: 4355-4358 (a weighted average of the amino acids at a given position).

### EXAMPLES

### Example 1

### E-Value Changes with the Change of Database Size

Query sequence: 30 amino acids from a major allergen I plus 30 amino acids of Cry1F: EICPAVKRDV DLFLTGTPDE YVEQVAQYKA HVLNHVTFVR WPGEISGSDS WRAPMFSWTH RSA (SEQ ID NO: 1). Search algorithm for the GenBank non-redundant protein database: FASTA36 at world wide website //fasta.bioch.virginia.edu/fasta_www2/fasta_www.cgi. Databases used include: (1) GeneBank non-redundant protein sequences; (2) various allergen databases; and (3) one-to-one with the GanBank accession NP_NP_{—}001041618.1. E-value comparison of the alignment between the query and the same target protein.

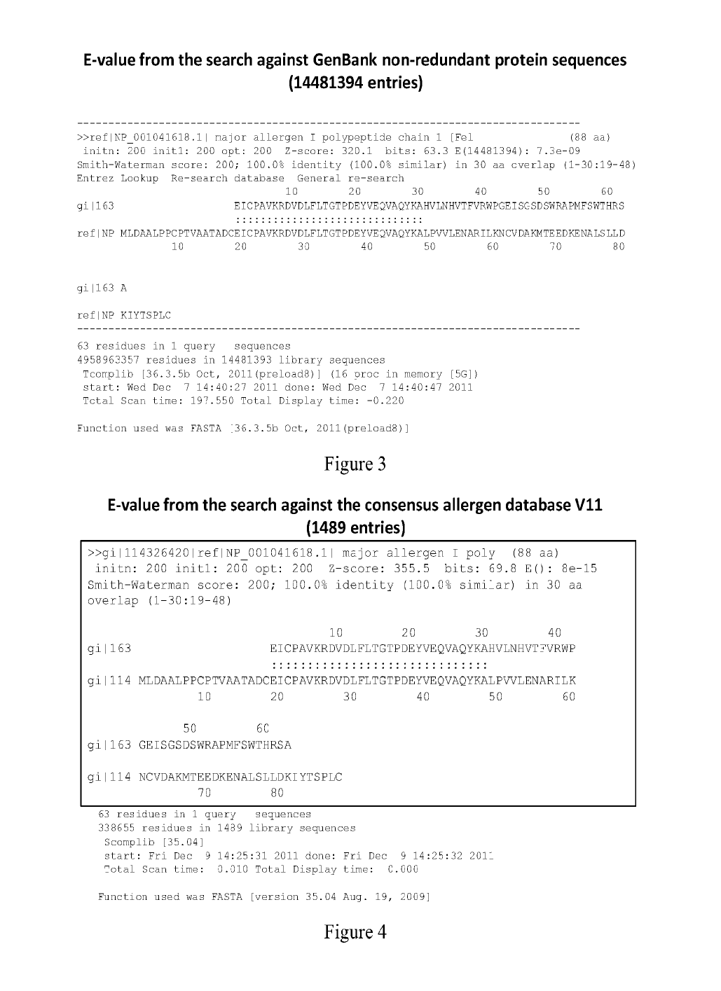

An exemplary E-value from the search against GenBank non-redundant protein sequences is shown in FIG. 3. The database size is 14,481,394 sequences including the query protein. The E-value is determined as 7.3×10⁻⁹ to major allergen I polypeptide chain 1.

Another exemplary E-value from the search against the consensus allergen database V11 is shown in FIG. 4. The database size is 1,489 sequences. The E-value is shown as 8×10⁻¹⁵ to major allergen I polypeptide. This E-value is much smaller as compared to FIG. 3 because of the smaller database.

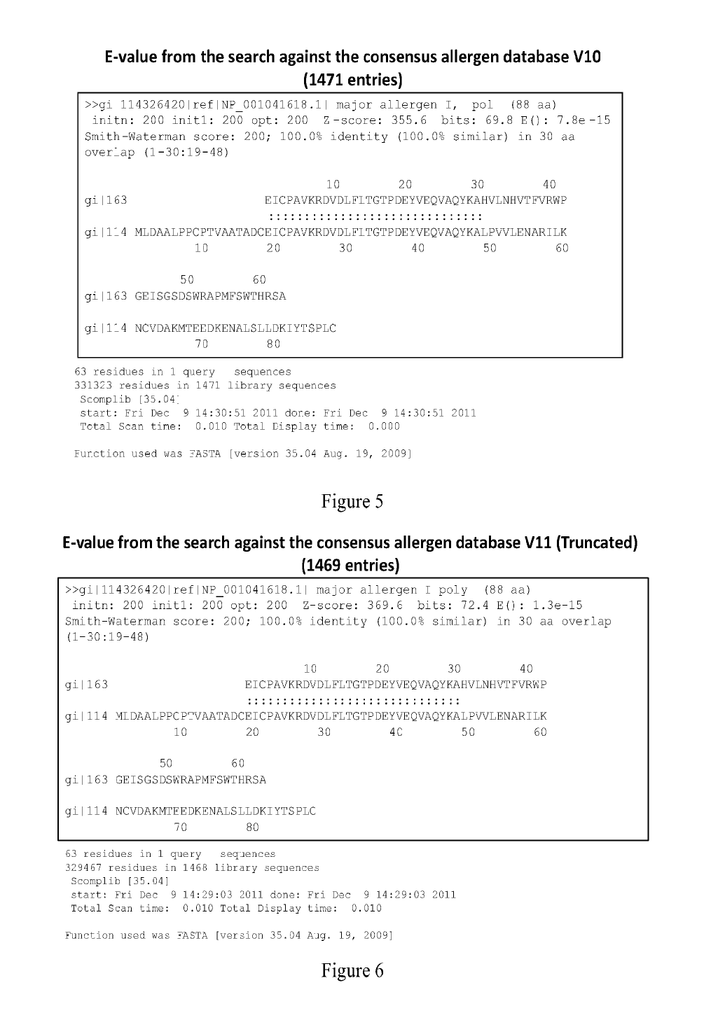

Another exemplary E-value from the search against the consensus allergen database V10 is shown in FIG. 5. The database size is 1,471 sequences. The E-value is shown as 7.8×10⁻¹⁵ to major allergen I polypeptide. This E-value is also much smaller as compared to FIG. 3 because of the smaller database.

Another exemplary E-value from the search against the consensus allergen database V11 (truncated) is shown in FIG. 6. The database size is 1,469 sequences. The E-value is shown as 1.3×10⁻¹⁵ to major allergen I polypeptide. This E-value is also much smaller as compared to FIG. 3 because of the smaller database.

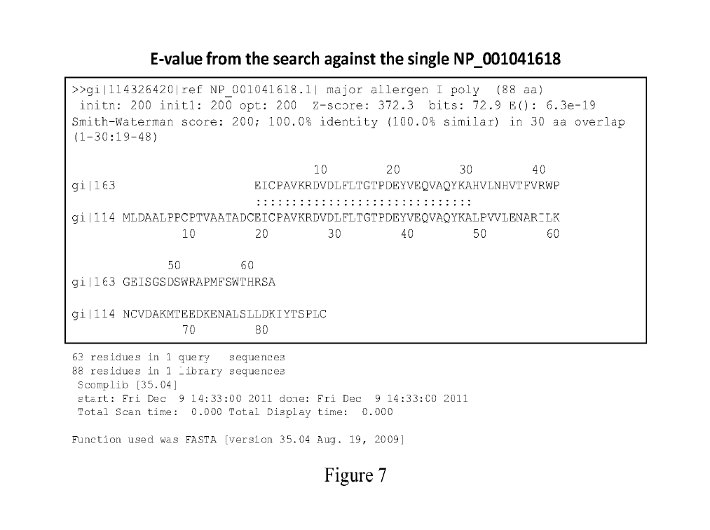

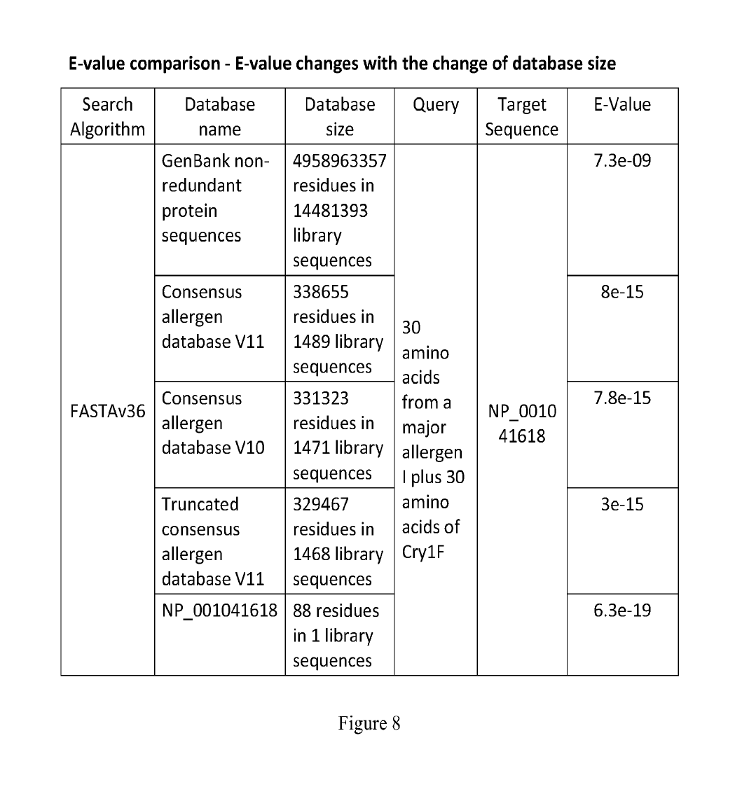

An extreme E-value from a database with only one sequence—the major allergen I polypeptide is shown in FIG. 7. The E-value is shown as 6.3×10⁻¹⁹ to major allergen I polypeptide. This E-value is much smaller as compared to FIGS. 3-6 because of the database is extremely small with only one sequence. FIG. 8 shows a summary of E-values calculated from different databases according to FIGS. 3-7.

This particular example demonstrates that E-values can change significantly due to different sizes of databases. In each search shown in FIGS. 3-7, the search engine identifies the same allergen protein—the major allergen I polypeptide. However, the E-values changes significantly when different databases are used. For regulatory submission purpose, it is challenging to use such E-values as major criteria for allergen prediction because of the E-value's dependence on database sizes.

### Example 2

### Stable Pair-Wise E-Value Generation

FIG. 1 shows an exemplary embodiment of the systems and methods provided herein. The sequence of a query protein is input into a stable pair-wise E-value module (FASTA or BLAST program) to generate a stable E-value with each sequence in the selected allergen database. Accordingly, one stable pair-wise E-value is generated for each sequence is the selected allergen database. All the stable pair-wise E-values (against all sequences in the selected allergen database) are then input into a classification module for determining allergen potential of the query protein. The classification module can determine potential allergen output based on the comparison of the stable pair-wise E-values with a pre-determined E-value threshold. All sequences in the selected allergen database having a stable pair-wise E-value equal or smaller than a pre-determined value will be regarded as “potential allergen hits” for the query protein. On the other hand, all sequences in the selected allergen database having a stable pair-wise E-value larger than a pre-determined value will be regarded as “not potential allergen” for the query protein.

The same process can be repeated again using a different database, which may include certain overlapping sequences already in the previous selected allergen database. According to the systems and methods provided, each of these overlapping sequences will generate the same stable pair-wise E-value against the query protein regardless which database is used for these overlapping sequences. Thus, the “potential allergen hits” will be consistent from difference databases where the stable pair-wise E-value remains the same regardless which database is used to generate between the query protein and the allergen sequence (for example, certain overlapping sequences among different databases).

What is claimed is:

1. A computerized system for stable pair-wise E-value generation and/or allergen classification for a query sequence, comprising,
(a) an input device and an output device/interface;
(b) an analysis system interface coupled to memory of a computer;
(c) an operating system comprising at least one database;
(d) a stable pair-wise E-value module; and
(e) a classification module.

2. The computerized system of claim 1, wherein the input device is selected from the group consisting of any amino acid sequence, automated sequencer, sequencing data input device, and sequencing data storage device.

3. The computerized system of claim 1, wherein the output interface comprises a list of potential allergen hits.

4. The computerized system of claim 1, wherein the at least one database comprises a consensus allergen database.

5. The computerized system of claim 1, wherein the stable pair-wise E-value module generates one stable pair-wise E-value for the query sequence against each sequence in the database used.

6. The computerized system of claim 2, wherein the classification module classifies sequences in the database used based on a pre-determined E-value.

7. The computerized system of claim 6, wherein the pre-determined E-value is equal or less than 0.1.

8. The computerized system of claim 6, wherein the pre-determined E-value is from 0.1 to 1×10⁻¹⁰.

9. The computerized system of claim 5, wherein the stable E-value is independent of the size of database used.

10. The computerized system of claim 5, wherein the stable pair-wise E-value for the query sequence against a particular sequence in the database is independent of the size of the database used.

11. A method for use in a computerized system for stable pair-wise E-value generation and/or allergen classification for a query sequence, comprising,
(a) generating a stable pair-wise E-value for the query sequence against each sequence in a first database using a stable pair-wise E-value module; and
(b) classifying the query sequence based on a pre-determined E-value using a classification module.

12. The method of claim 11, further comprising outputting a list of potential allergen hits to a user.

13. The method of claim 12, wherein the list of potential allergen hits comprises sequence alignments between the query sequence and each of the known allergens in the database.

14. The method of claim 13, wherein the sequence alignments are performed using FASTA or Basic Local Alignment Search Tool (BLAST).

15. The method of claim 12, further comprising repeating steps (a) and (b) with a second database.

16. The method of claim 15, wherein the first or second database is derived from the National Center for Biotechnology Information (NCBI).

17. The method of claim 11, wherein the first database comprises a consensus allergen database.

18. The method of claim 11, further comprising repeating steps (a) and (b) with a different query sequence.

19. The method of claim 11, wherein the computerized system comprises a system of claim 1.

20. The method of claim 11, wherein the pre-determined E-value is equal or less than 0.1.

21. The method of claim 11, wherein the pre-determined E-value is from 0.1 to 1×10⁻¹⁰.

22. The method of claim 11, wherein the stable pair-wise E-value is independent of the size of database.

23. The method of claim 11, wherein the stable pair-wise E-value for the query sequence against a particular sequence in the database is independent of the database.

24. The method of claim 11, wherein the query sequence is a protein or amino acid sequence.

25. The method of claim 11, wherein the query sequence is a nucleic acid sequence.

26. The method of claim 25, wherein the nucleic acid sequence is a DNA or RNA sequence.


SEQUENCE LISTING (2 sequences)

SEQ ID NO: 1 - protein, 63 aa, Bacillus thuringiensis
EICPAVKRDVDLFLTGTPDEYVEQVAQYKAHVLNHVTFVRWPGEISGSDSWRAPMFSWTHRSA

SEQ ID NO: 2 - protein, 88 aa, Felis catus
MLDAALPPCPTVAATADCEICPAVKRDVDLFLTGTPDEYVEQVAQYKALPVVLENARILKNCVDAKMTEEDKENALSLLDKIYTSPLC